(19) United States
(12) Patent Application Publication
(10) Pub. No.: US 2026/0031652 A1
(43) Pub. Date: Jan. 29, 2026

(54) SYSTEM AND METHOD FOR IMPLEMENTATING A MAGNET BATTERY

(71) Applicant: Sally Seaver, Athol, MA (US)

(72) Inventor: Sally Seaver, Athol, MA (US)

(21) Appl. No.: 18/783,276

(22) Filed: Jul. 24, 2024

(51) Int. Cl. H02J 15/00; H01J 3/38; H02K 1/02

(52) U.S. Cl. CPC H02J 15/006; H01J 3/38; H02K 1/02

(57) ABSTRACT

An illustrative battery is provided. The battery includes a container and a lead wire positioned within the container. The lead wire includes a first end and a second end. A vacuum chamber is positioned within the container and coupled to the second end of the lead wire. The vacuumed chamber including a plurality of charged particles circulating a magnet causing opposite charges to accumulate between the first end and the second end of the lead wire, resulting in a voltage difference in the lead wire. The voltage difference is supplied to a circuit using the first end of the lead wire.

### BACKGROUND

Batteries are capable of accepting, storing, and releasing electricity. Like many other common energy sources, they use chemistry, specifically chemical potential, to store energy. For batteries to function, electricity needs to be converted into a chemical potential form before it can be easily stored. Batteries are made up of two electrical terminals—the cathode and the anode—which are separated by a chemical material called an electrolyte. To accept and release energy from the battery, the battery needs to be connected to an external circuit.

Electrons flow through the circuit, while ions (electrically charged atoms or molecules) move through the electrolyte. In a rechargeable battery, electrons and ions can move in either direction through the circuit and electrolyte. Electrons moving from the cathode to the anode increase the chemical potential energy, thus charging the battery. When they move in the opposite direction, they convert this chemical potential energy to electricity in the circuit, discharging the battery. During charging or discharging, oppositely charged ions move inside the battery through the electrolyte to balance the charge of the electrons moving through the external circuit, creating a sustainable, rechargeable system. Once charged, the battery can be disconnected from the circuit, storing the chemical potential energy for later use as electricity.

There is a need for a battery that does not use chemical cells. There is a need for a battery that can:
1. store energy for a long time with negligible degradation
2. store energy for a long time safely, unlike the widely used lithium-ion batteries
3. provide excellent power to mass ratio (specific power)
4. not poison trash sites
5. support the electrical grid with significant backup power for the intermittency of wind and solar power sources
   The magnet battery uses the physics of a magnetic field and charged particles to store power and supply a voltage difference to an external circuit, no chemical cells.

### SUMMARY

According to one aspect of the subject matter described in this disclosure, an illustrative battery is provided. The battery includes a container and a lead wire positioned within the container. The lead wire includes a first end and a second end. A vacuum chamber is positioned within the container and coupled to the second end of the lead wire. The vacuumed chamber including a plurality of charged particles circulating a magnet causing opposite charges to accumulate between the first end and the second end of the lead wire, resulting in a voltage difference in the lead wire. The voltage difference is supplied to a circuit using the first end of the lead wire.

In some implementations, the container may include borosilicate glass coated with silicone rubber or ethylene propylene diene terpolymer (EPDM). The lead wire may be a copper rod or bar. The magnet may be a neodymium magnet. The vacuum chamber may include walls of borosilicate glass. The circuit may include a load directly connected to the lead wire. The lead wire may act like a point source of charge, causing oppositely charged particles to collect on a wire or endpoint of a wire of the circuit, thus producing a voltage difference. The lead wire may include sufficient distance from the magnet, so effects of magnetic fields produced by the magnet are negligible. The charged particles circulating the magnet may be provided to the vacuum chamber using an electron gun or ion gun. The vacuum chamber may include getter material to help preserve a vacuum in the vacuum chamber.

According to another aspect of the subject matter described in this disclosure, an illustrative energy device is provided. The energy device includes an energy confinement device for supplying an electromotive force to a circuit, the energy confinement device comprises: a plurality of lead wires; and a vacuum chamber positioned within the energy confinement device, the plurality of lead wires positioned around the vacuum chamber, the vacuum chamber including a magnet with a plurality of charged particles circulating the magnet resulting in a voltage difference produced in each of the lead wires. The voltage difference in at least one of the lead wires is supplied to a circuit when a lead wire is coupled to the circuit. A servo motor system is coupled to the energy confinement device, for changing the lead wire coupled to the circuit to a different lead wire when charges in the lead wire have depleted.

In some implementations, the lead wires may be copper rods or bars. The magnet may be a neodymium magnet. The walls of the container and vacuum chamber may include alumina ceramic. The circuit may include a load directly connected to the lead wire coupled to the circuit. The lead wire coupled to the circuit may act like a point source of charge, causing oppositely charged particles to collect on a wire or endpoint of a wire of the circuit, thus producing a voltage difference. The lead wires may include sufficient distance from the magnet, so effects of magnetic fields produced by the magnet are negligible. The energy confinement device may be baked in a vacuum oven. Then the energy confinement device may be. assembled in a vacuum laser glove box or an electron beam welding machine. The energy confinement device may include at least one opening to receive an electron gun or ion gun. The charged particles circulating the magnet may be provided using to the vacuum chamber using an electron gun or ion gun. The vacuum chamber may include getter material to help preserve a vacuum in the vacuum chamber

According to another aspect of the subject matter described in this disclosure, an illustrative method for delivering voltage to a device is provided. The method includes: coupling an energy device to a circuit in the device, where the energy device comprising: a container; a lead wire positioned within the container, the lead wire including a first end and a second end; and a vacuum chamber positioned within the container and coupled to the second end of the lead wire, the vacuumed chamber including a plurality of charged particles circulating a magnet causing opposite charges to accumulate between the first end and the second end of the lead wire, resulting in a voltage difference in the lead wire; and supplying the voltage difference to the device by coupling the first end of the lead wire to the circuit.

Additional features and advantages of the present disclosure is described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIGS. 1A-1C are schematic diagrams of forming an illustrative magnet battery.

FIG. 2 is a cross-sectional view of an illustrative vacuum chamber used by a magnet battery, as shown in any of FIGS. 1A-1C.

FIGS. 3A-3D are schematic diagrams of circuits used with one or more magnet batteries, as shown in any of FIGS. 1A-1C.

FIG. 4 is a schematic diagram of an illustrative high-capacity energy device.

FIGS. 5A-5C are detailed schematic diagrams of an illustrative energy containment device, as shown in FIG. 4.

FIGS. 6A-6B are schematics of circuits using a high-capacity energy device, as shown in FIG. 4.

FIG. 7 shows an illustrative process for delivering voltage to a device.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

The disclosure describes the features of a magnet battery designed for long-term energy storage. The key features include:
1. Reliance on the physics of electromagnetism, not chemical reactions
2. Long-term energy storage with no degradation
3. Safe long-term energy storage
4. Excellent power-to-mass ratio, high specific power
5. Disposal does not poison trash sites
6. Supports the electrical grid with significant backup power for the intermittency of wind and solar power
   As with other batteries, energy can be withdrawn using an electromotive force (emf). This battery functions like a capacitor, storing energy physically rather than chemically. It can offer a wide range of capacities and has versatile applications, including replacing 1.5 V alkaline batteries in small devices or as high-capacity batteries such as 200 kV batteries in cars, trains, jets, ships, and similar uses. Moreover, the disclosure describes a super-high-capacity energy device (greater than 200 kV) that utilizes an assembly of lead wires and a magnet to provide electrical capacity to a utility's power grid.

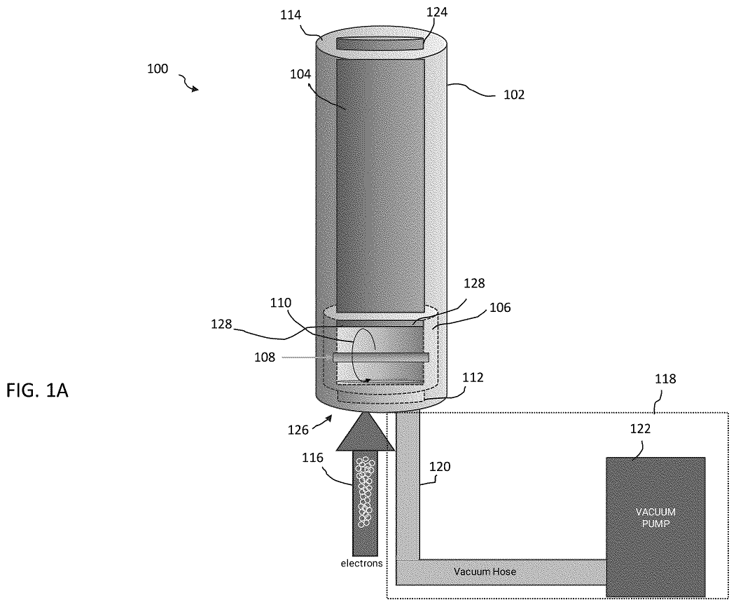

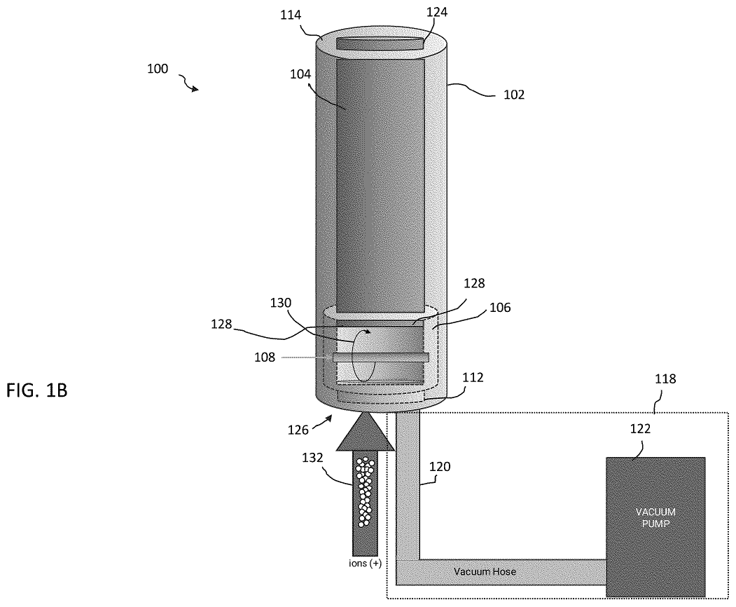

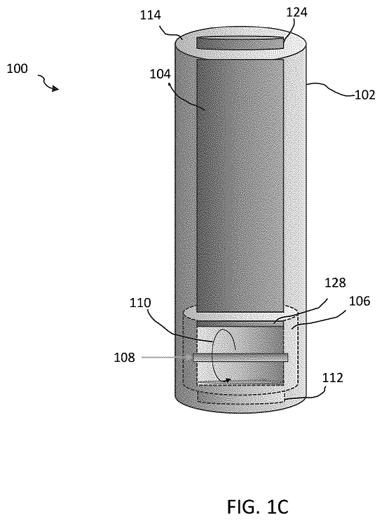

FIG. 1A-1C are schematic diagrams of forming an illustrative magnet battery 100. FIG. 1A shows magnet battery 100, including electron gun 116 used for charge injection into the device and vacuum generator 118 used for creating the vacuum in the vacuum chamber. Note that the charge injection can also be positive ions from an ion gun as depicted in FIG. 1B. The magnet battery 100 includes a container 102 containing a lead wire 104 and a vacuum chamber 106. One end of the lead wire 124 may pass through the surface 114 to extend beyond surface 114 . . . . Or this first end of the lead wire 104 could terminate at the surface 114 of the container 102. The opposite end of the lead wire 128 is flush with the interior wall of the vacuum chamber 106 and positioned perpendicular to—but not touching—the circling charged particles 110. The vacuum chamber 106 includes a magnet 108. Charge particles 110 rotate around this magnet 108. Getter material is commonly applied inside the vacuum chamber 106 to help preserve the vacuum. A neck 112 may be positioned adjacent to vacuum chamber 106 configured to receive electrons or ions 116 or a vacuum hose 120 via an opening in surface 126 of the container 102.

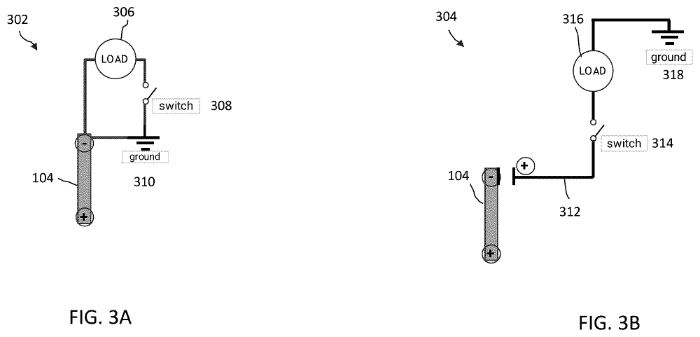

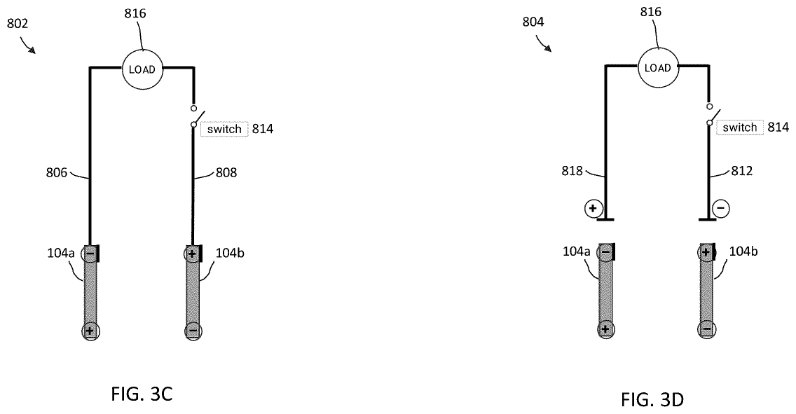

The rotating charged particles 110 attract free charge in the closest end of the lead wire 128, free charge that has the opposite sign to the charged particles rotating around the magnet. This creates a voltage difference between the opposite ends of the lead wire 124 and 128. The end of the lead wire that terminates outside the container 124 can function in one of two ways. One, it functions as a point charge to an external circuit, FIG. 3B. The difference between this source of charge from the end of the lead wire and ground provides a voltage difference that can acts as an electromotive force (emf). Two, if the magnet battery is connected directly to a circuit, then free charge flows from the lead wire into the circuit interacting with other higher or lower points of charge within the external circuit, FIG. 3A. Further details regarding producing this voltage difference are described further below.

When charged particles are injected perpendicular to a magnetic field, they rotate in the magnetic field. This is known physics. Fₘ=qvB for charged particles injected perpendicular to a magnetic field; where Fₘ is the center-directed force acting on a charged particle, q is the charge of the particle, vis the velocity of the particle as it gets injected perpendicular to the magnetic field, and B is the strength of the magnetic field which is supplied by the magnet 108; no work is involved for the electrons or positive ions to circle the magnet, thus they rotate perpetually as long as the vacuum is in effect. The charge particles 110 may be electrons, as shown in FIG. 1A or positive ions 130, as shown in FIG. 1B.

Neodymium magnets weaken only 1% to 2% every 10 years. The charged particles may rotate the magnet with a weakened magnetic field; in this case, the force Fₘ is weaker making the radius of the circling charges larger.

The vacuum generator 118 includes a vacuum hose 120. During manufacture, the vacuum hose 120 is connected to neck 112 at one end, and the other is connected to a vacuum pump 122. When the vacuum hose 120 is connected to neck 112, it creates a vacuum environment in vacuum chamber 106 by using vacuum pump 122; this allows gases to be expelled out via vacuum hose 120.

While vacuum chamber 106 is under vacuum, an electron gun 116 or ion gun 132 can be fired directly towards magnet 108 via neck 112 inside vacuum chamber 106. The charge particles 110 may be electrons, as shown in FIG. 1A, due to electron gun 116 delivering electrons to vacuum chamber 106. Or, the charge particles 130 may be positive ions as shown in FIG. 1B, due to an ion gun 132 delivering ions to vacuum chamber 106. Note the rotation of charge particles 110 in FIG. 1A and 130 in FIG. 1B is different due to the difference in the charge of the circulating particles. Subsequently, the neck 112, while under vacuum, is melted and crimped closed in front of the vacuum hose 120. FIG. 1C illustrates the completed magnet battery 100.

To increase the voltage provided by the magnet battery 100, one can adjust the dimensions of the container 102, lead wire 104, vacuum chamber 106, the magnetic strength of the magnet, and/or the current of charge being discharged from the electron gun 116 or ion gun 132. The lead wire 104 can be made of copper or any conductive wire with a high free charge capacity. The container 102 may consist of borosilicate glass coated with silicone rubber, ethylene propylene diene terpolymer (EPDM), or similar insulating and protective material. The vacuum chamber 106 and neck 112 may also be made of borosilicate glass or similar materials.

In some implementations, a 2-Volt AA battery may be formed using magnet battery 100. In this case, the lead wire 104 may be a copper rod with a diameter of 5 mm and a length of 39 mm. The magnet 108 may be a cylindrical neodymium magnet N42 strength, 1/16 in diameter×¼ in height (1.59 mm×6.35 mm) The height of the container may be 50.5 mm. Electrons may be injected with a 1 nA current and a 1 mm spot for 0.1 seconds.

In some implementations, a 10.6-Volt D battery may be formed using magnet battery 100. In this case, the lead wire 104 may be a copper rod with a diameter of 8 mm and a length of 43.5 mm. The magnet 108 may be a cylindrical neodymium magnet N42 strength, 1/16 in diameter×⅜ in height (1.59 mm dia×9.525 mm). The length of the container may be 61.5 mm. Electrons may be injected with a 1 nA current and a 1 mm spot for 0.4 seconds.

In some implementations, a 200-kVolt battery may be formed using magnet battery 100. In this case, the lead wire 104 may be a copper rod with a diameter of 31.75 mm and a length of 152.4 mm. The magnet 108 may be a cylindrical neodymium magnet N42 9.525 mm diameter×38.1 mm height. The length of the container may be 195 mm. Electrons may be injected with a 1 uA current and a 20 mm spot for 5 seconds.

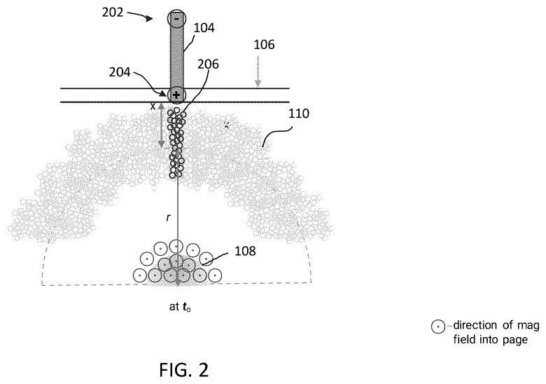

FIG. 2 is a cross-sectional view of an illustrative vacuum chamber used by a magnet battery, as shown in any of FIGS. 1A-1C. The lead wire 104 may be fixed in place, with near-end 204 exposed to the vacuum chamber 106 and far-end 202 exposed to air to connect in a circuit. This causes the holes to separate from the electrons in the lead wire 104. The lead wire 104 may be a solid copper rod or other conducting material with free charge. The free charges in the lead wire 104 move in the lead wire in keeping with Coulomb's Law and the Lorentz force. If electrons are circling the magnet, then positive charges aggregate on the end of the lead wire closest to these electrons and free electrons in the wire move to the far end 202 of the lead wire 104. If positive ions are circling the magnet, then electrons aggregate on the near end 204 of the lead wire and positively-charged holes move to aggregate on the far end 202. (Holes are particles having the absence of electrons which thus carry a positive charge).

The lead wire 100 has enough distance from magnet 108 so that the effects of the magnetic fields produce by magnet 108 are negligible. At any instant of time, to, the free charge in the lead wire 104 will experience a Coulomb force due to the charges near it in the dashed rectangle 206. This charge noted in the dashed rectangle 206 repels same sign charges in lead wire 104 and attracts opposite sign charges. A voltage difference will be created in lead wire 104 so that the far end 202 will be able to supply a voltage difference from ground. The charges in the dashed rectangle 206 are not stationary, thus the Lorentz force from electric and magnetic fields acting on the free charges in the lead wire 104 also plays a role. The result of the Lorentz force acts on the free charges in the lead wire 104 in the same direction as the force due to Coulomb's Law.

FIGS. 3A-3B are schematic diagrams of circuits 302 and 304 used with a magnet battery, as shown in any of FIGS. 1A-1C. FIG. 3A shows circuit 302, including lead wire 104 of the magnet battery 100, representing a voltage source directly connected to load 306. The load 306 may be connected to a switch 308. Switch 308 may be connected to ground 310. When switch 308 is closed, circuit 302 is fully operational, resulting in lead wire 104 supplying a voltage and/or current to load 306.

The voltage in lead wire 104 can be maintained if there are free charges present. As electrons exit the far end of lead wire 104, new electrons replace them until all the free charge in lead wire 104 is depleted. For instance, a circuit with a 600-lumen lightbulb load may use 0.943 Coulombs per second or 2.122×10²² electrons per hour. In this scenario, lead wire 104 is assumed to be a copper wire with a diameter of 8 mm and a length of 43.5 mm (D battery) and contains 1.86×10²³ free electrons. Lead wire 104 can maintain a constant drain to power the lightbulb for 8.7 hours. Unlike lithium-ion batteries, there is virtually no degradation when the battery is not in use.

In FIG. 3B, circuit 304 is shown, including lead wire 104. Electrons from lead wire 104 do not exit from its far end. The lead wire 104 acts like a point source of charge, collecting positive charges on the endpoint of wire 312, thus producing a voltage difference. A switch 314 is positioned between wire 312 and load 316. The load 316 is connected to ground 318. When switch 316 is closed, circuit 304 becomes fully operational, resulting in the voltage difference between the lead wire 104 and wire 312 being supplied to load 316.

In this case, the positive charge in wire 312 may be moving towards the negative charge of lead wire 104 due to a higher voltage difference. If the charge on lead wire 104 is maintained at its far end without shedding electrons, the point source of charge can be sustained for approximately 50 years or until the lack of a perfect vacuum erodes the rotating electrons 110 in the vacuum chamber 106 beyond a threshold level. At that point, magnet 108 would lose 5% to 10% of its strength.

Another two types of circuits may be envisioned using the magnet battery 100. FIGS. 3C-3D are schematic diagrams of circuits 802 and 804 used with a magnet battery, as shown in any of FIGS. 1A-1C.

FIG. 3C shows circuit 802, including one lead wire 104a of the magnet battery 100 with a negative-charge endpoint as in FIG. 1A connected to the circuit AND another lead wire 104b with a positive-charge endpoint as in FIG. 1B connected to the circuit. Lead wires 104a and 104b provide a voltage source directly to the circuit powering the load 306. The load 306 may be connected to a switch 308. When switch 308 is closed, circuit 302 is fully operational, supplying a current to load 306. Over time, the charge that is initially present in lead wire 104a and 104b will be depleted.

In FIG. 3D, circuit 804 is shown, including lead wire 104a and lead wire 104b. Electrons from lead wire 104a and 104b do not exit from their respective endpoints that are coupled to the circuit. The lead wire 104a acts as a point source of negative charge, collecting positive charges on the endpoint of wire 818. The lead wire 104b acts as a point source of positive charge collecting negative charges on the endpoint of wire 812. Together, both the negative point charge and positive point charge supply an emf to the circuit; however, they do so without losing charge. A switch 814 is positioned between wire 812 and load 816. When switch 816 is closed, circuit 804 becomes fully operational, resulting in the voltage difference between the endpoint of wire 818 and the endpoint of wire 812. This supplies current to load 816.

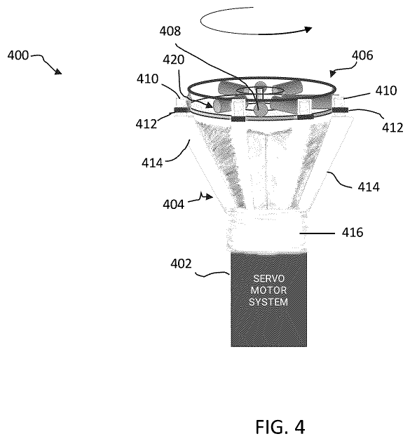

FIG. 4 is a schematic diagram of an illustrative super-high-capacity energy device 400. This super-high-capacity energy device 400 includes a servo motor 402, a coupler 404, and an energy containment device 406. The servo motor 402 is connected to coupler 404. The coupler 404 is connected to energy containment device 406. The energy containment device 406 includes an assembly of lead wires 408 angularly arranged within energy containment device 406.

The servo motor system 402 includes a gear box designed to rotate coupler 404, which in turn circularly rotates the energy containment device 406. The servo motor system 402 rotates the energy containment device 406 at a specific time intervals that match the time it takes to deplete the charge from one of the lead wires 408. This enables a different lead wire 408 to be connected to a load when one of the lead wires 408 is depleted of charge. The servo motor system 402 may be a rotary actuator that provides precise control of the angular position of lead wires 408. Additionally, the servo motor system 402 may consist of a motor coupled to a sensor for position feedback. In certain implementations, the servo motor system 402 may necessitate a servo drive to complete the system. The servo drive uses the feedback sensor to control the precise rotary position of the motor.

The energy containment device 406 is a container that includes a vacuum chamber with a magnet positioned in the middle region. This magnet has electrons rotating around it, similar to magnet 108 in FIGS. 1A-1C. Lead wires 408 are placed within the energy containment device 406. Each lead wire 408 is positioned at an angle relative to the others. In some implementations, each of 7 lead wires 408 may be placed at 45-degree angles from each other, however, the number of wires may be different for different implementations. Similar to the magnet battery case, each lead wire 408 is exposed to the electric and magnetic fields caused by the rotating charges around the magnet, causing opposite charges to accumulate at the near and far ends of each lead wire 408 producing a voltage difference. Also, a portion 420 of each lead wire 408 extends external the energy containment device 406 allowing for a circuit with a load to be connected to a lead wire 408. More details of the energy containment device 406 are provided below.

The coupler 404 includes several threaded posts 410 positioned on fins 414 used for connecting energy containment device 406 to coupler 404. The bottom of each fin 414 is attached to a collar 416. The collar 416 fits over (or fits into) servo motor system 402. The energy containment device 406 includes several tabs 412 each with a hole that receives a threaded post 410 from the coupler. When each threaded post 410 is inserted into the corresponding tab 412, then a fastener such as a nut is used for securely locking energy containment device 406 to coupler 404. Also, the coupler 404 provides sufficient distance between energy containment device 406 and servo motor system 402 to minimize any detrimental effects of their electrical components due to the various magnetic and/or electrical fields produced by servo motor system 402 and/or energy containment device 406.

In some implementations, the coupler 404 may be fabricated using 3-D printing with suitable metal such as aluminum or the like. In some implementations, the number of tabs, threaded posts and fasteners may vary from those shown in FIG. 4. In some implementations, the tabs 412 may be nuts configured to secure energy containment device 406 onto coupler 404.

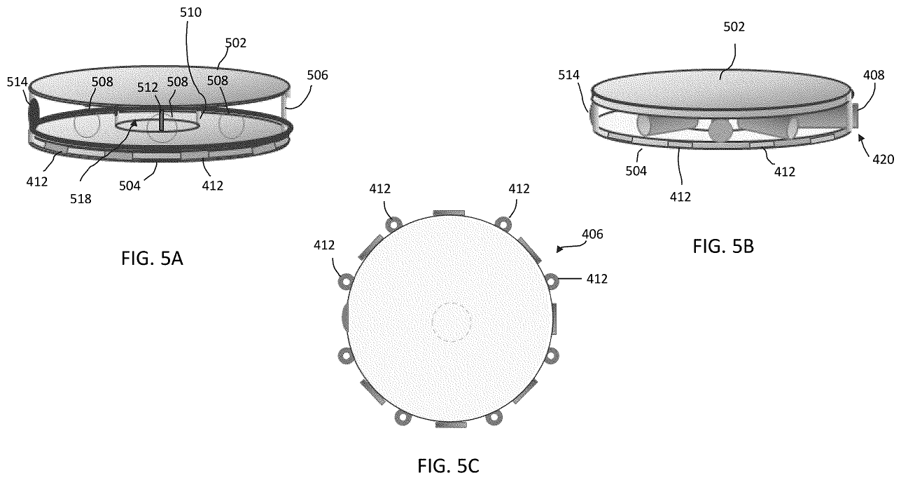

FIGS. 5A-5B are detailed schematic diagrams of an illustrative energy containment device, as shown in FIG. 4. FIG. 5A shows energy containment device 406 without lead wires 408. In this implementation, the energy containment device 406 includes a circular top surface 502 and a circular bottom surface 504. The bottom surface 504 includes tabs 412, as shown in FIG. 5C, that extend out from the bottom 504 used to connect energy confinement device 406 to coupler 404. An outer wall 506—which is transparent—connects top surface 502 and bottom surface 504 to make a hermetic seal. Moreover, the outer wall 506 includes several openings 508. Each opening 508 is configured to receive one end of the lead wires 408 that are placed in the interior of energy containment device 406. An inner wall 510—which is transparent in the Figure, having a substantially circular shape, is positioned in the interior of energy confinement device 406. It has the same number of openings as the outer wall that are configured to receive the inner end of each lead wire. This inner wall 510 forms the inner vacuum chamber for the magnet and circling charged particles. The top and bottom portions of the inner wall 510 are hermetically connected to top surface 502 and bottom surface 504. The region of the interior of energy confinement device 406 enclosed by the inner wall 510 defines a vacuum chamber 518 containing a magnet 512 and the rotating charges 110.

The top surface 502, bottom surface 504, outer wall 506, and inner wall 510 may be comprised of alumina ceramic. In some implementations, the top surface 502, bottom surface 504, outer wall 506 and inner wall 510 may be comprised of quartz, an excellent insulator. The magnet 512 may be a neodymium magnet or other type of magnet. In some implementations, the magnet 512 may have a diameter of less than 9.525 mm and a length of less than 38.1 mm. Each lead wire 408 may be a solid copper rod or other conducting material with abundant free charge. Each metallic lead wire 408 may have its sides—not ends—coated with a nonreflective insulating material such as polyethylene, Teflon, or silicone rubber. Also, each lead wire 408 may have a diameter of less than 31.75 mm and a length of less than 152.4 mm.

Before joining the top surface 502, bottom surface 504, outer wall 506, and inner wall 510 together with hermetic seals, all parts except the magnet are baked in a vacuum oven, then passed under vacuum to a vacuum laser glove box or an electron beam welding machine. The remainder of the energy containment device may be assembled under vacuum in the laser glove box or electron beam welding machine. An electron gun or an ion gun needs to operate under vacuum; a hole is left open in both the outer and inner walls of the container for allowing an electron gun or ion gun to discharge charged particles straight towards the magnet in the inner vacuum chamber.

A plug 514 is hermetically sealed into place over the hole in the outer wall 506 at the end of the manufacturing process. The opening in the inner wall may or may not also be plugged. When lead wires 408 are placed in the energy confinement device 406, as shown in FIG. 5B, and hermetically sealed in place, the charges 110 circling magnet 512 causes opposite-charge free charge in each lead wire 408 to move to the inner end of the lead wire while same-charge free charge moves to the outer end of the lead wire. This creates a voltage difference in each lead wire 408. A portion of each lead wire 408 extends external the energy confinement device 406 so each lead wire 408 may be coupled to a circuit having a load.

Although an electron gun and ion gun are referred to in the description above, any approach that can insert electrons (or ions) into a vacuum chamber so that they have the desired velocity and charge density is an acceptable means of achieving charges 110 circling the magnet.

Maintaining a strong vacuum inside device 406 is important. Getter material may be applied inside the inner vacuum and/or the outer chamber of the container. All seals of parts of device 406 including the plug 514 are hermetic seals.

In some implementations, a 400-kVolt battery for 1000 A circuits may be formed using energy containment device 400. In this case, each lead wire 408 may be a copper rod with a diameter of 38.1 mm and a length of 254 mm. The magnet 512 may be a cylindrical neodymium magnet N42 9.525 mm diameter×50.8 mm height. The inner circumference of the vacuum chamber may be 80 mm; the diameter of the container may be 59 cm. Electrons may be injected with a 1 μA current and a 5 mm spot for 10 seconds.

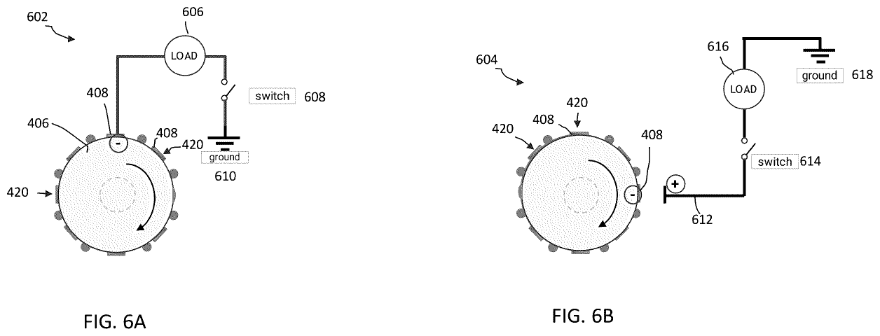

FIGS. 6A-6B are schematics of circuits 602 and 604 using a super-high-capacity energy device, as shown in FIG. 4. In circuits 602 and 604, the servo motor system 402 may turn energy confinement device 406 so that when the electrons from one lead wire 408 are depleted another lead wire 408 can be used. The lead wires 408 are all powered by the same rotating electrons in vacuum chamber 512. FIG. 6A shows the energy confinement device 406 of super-high-capacity energy device 400 being part of circuit 602 where a load 606 is electrically connected to one of the lead wires 408 and a switch 608. Switch 608 is connected to ground 610. When switch 608 is closed, circuit 602 is fully operational, resulting in the connected lead wire 408 supplying a voltage and/or current to load 606. Once the connected lead wire 408 is depleted of charge, servo motor system 402 rotates energy confinement device 406 to a different lead wire 408 to continue supplying voltage to circuit 302.

FIG. 6B shows the energy confinement device 406 of a super-high-capacity energy device 400 being part of circuit 604. A wire 612 is electrically coupled to one of the lead wires 408. Charged particles from the lead wire 408 do not exit from its far end. The exposed end of the lead wire 408 acts as a point source of charge, collecting oppositely charged particles on the endpoint of wire 612, which produces a voltage difference. A switch 614 is positioned between wire 612 and load 616. The load 616 is electrically connected to ground 618. When switch 616 is closed, circuit 604 becomes fully operational, resulting in the voltage difference between the point charge at the end of lead wire 408 and wire 612 being supplied to load 616. Once the coupled lead wire 408 is depleted of charge, servo motor system 402 rotates the confinement device 406 to a different lead wire 408 to continue supplying voltage to circuit 602. If the charge on the connected lead wire 408 is maintained at its far end without shedding electrons, the point source of charge can be sustained for approximately 50 years, at which point the magnet 512 would lose 5% to 10% of its strength. Another factor affecting the life of the energy confinement device is the lack of a perfect vacuum which erodes the rotating electrons 110 in the vacuum chamber 518.

The manufacturing of the magnet battery and the energy confinement device requires the ability to: i) create a container with a vacuum chamber which requires hermetic seals, ii) inject charged particles and iii) seal the device so that the vacuum is maintained after the charged particles are circling the magnet. The feasibility of doing this manufacturing is indicated by the historically successful manufacturing of cathode-ray tubes. Cathode-ray tubes use a glass container, establish a vacuum inside and install an electron gun in the neck at the back of the device that is vacuum-sealed to be part of the device.

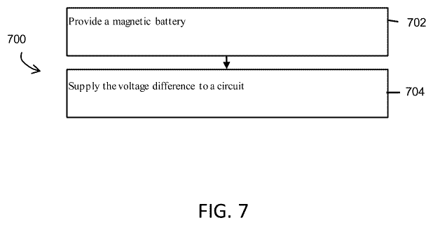

FIG. 7 shows an illustrative process 700 for delivering voltage to a device, such as loads 306, 316, 606, or 616. The process 700 includes: providing a magnet battery (such as magnet battery 100), the magnet battery comprising: a container (such container 102) (Step 702); a lead wire (such as lead wire 104) positioned within the cavity, the lead wire including a first end (such as portion 124) that extends external the hollow cavity; and a vacuum chamber (such as vacuum chamber 106) positioned within the hollow cavity and coupled to a second end of the lead wire, the vacuum chamber including a plurality of electrons or ions (such as electrons 110 or ions 130) circulating a magnet (such as magnet 108), causing opposite charges to accumulate between the first end and the second end of the lead wire, resulting in a voltage difference produced by the lead wire; and supplying the voltage difference to a circuit (such as circuits 302, 304, 602, or 604) by coupling the first end of the lead wire to the circuit (Step 704).

As the magnet battery or energy device is in use, the external circuit may consume free charge in the lead wire. An electron gun or ion gun can be used to renew free charge in the lead wire by firing charged particles at the exposed end of the lead wire. The magnet battery or energy device may be heated during this process so that the kinetic energy of atoms in the lead wire assists with uniform distribution of the added free charge. When a magnet battery or energy device uses a neodymium magnet, the temperature should not go higher than 175 degrees Celsius.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A battery comprising:
a container;
a lead wire positioned within the container, the lead wire including a first end and a second end; and
a vacuum chamber positioned within the container and coupled to the second end of the lead wire, the vacuumed chamber including a plurality of charged particles circulating a magnet causing opposite charges to accumulate between the first end and the second end of the lead wire, resulting in a voltage difference in the lead wire, wherein the voltage difference is supplied to a circuit using the first end of the lead wire.

2. The battery of claim 1, wherein the container comprises borosilicate glass coated with silicone rubber or ethylene propylene diene terpolymer (EPDM).

3. The battery of claim 1, wherein the lead wire is a copper rod or bar.

4. The battery of claim 1, wherein the magnet is a neodymium magnet.

5. The battery of claim 1, wherein the vacuum chamber comprises walls of borosilicate glass.

6. The battery of claim 1, wherein the circuit comprises a load directly connected to the lead wire.

7. The battery of claim 1, wherein the lead wire acts like a point source of charge, causing oppositely charged particles to collect on a wire or endpoint of a wire of the circuit, thus producing a voltage difference.

8. The battery of claim 1, wherein the lead wire includes sufficient distance from the magnet, so effects of magnetic fields produced by the magnet are negligible.

9. The battery of claim 1, wherein the charged particles circulating the magnet are provided to the vacuum chamber using an electron gun or ion gun.

10. The battery of claim 1, wherein the vacuum chamber includes getter material to help preserve a vacuum in the vacuum chamber.

11. An energy device comprising:
an energy confinement device for supplying an electromotive force to a circuit, the energy confinement device comprises:
a plurality of lead wires; and
a vacuum chamber positioned within the energy confinement device, the plurality of lead wires positioned around the vacuum chamber, the vacuum chamber including a magnet with a plurality of charged particles circulating the magnet resulting in a voltage difference produced in each of the lead wires, wherein the voltage difference in at least one of the lead wires is supplied to a circuit when a lead wire is coupled to the circuit; and
a servo motor system, coupled to the energy confinement device, for changing the lead wire coupled to the circuit to a different lead wire when charges in the lead wire have depleted.

12. The energy device of claim 11, wherein the lead wires are copper rods or bars.

13. The energy device of claim 11, wherein the magnet is a neodymium magnet.

14. The energy device of claim 11, wherein the walls of the container and vacuum chamber comprising alumina ceramic.

15. The energy device of claim 11, wherein the circuit comprises a load directly connected to the lead wire coupled to the circuit.

16. The energy device of claim 11, wherein the lead wire coupled to the circuit acts like a point source of charge, causing oppositely charged particles to collect on a wire or endpoint of a wire of the circuit, thus producing a voltage difference.

17. The energy device of claim 11, wherein the lead wires include sufficient distance from the magnet, so effects of magnetic fields produced by the magnet are negligible.

18. The energy device of claim 11, wherein the energy confinement device includes at least one opening to receive an electron gun or ion gun.

19. The energy device of claim 11, wherein the charged particles circulating the magnet are provided using to the vacuum chamber using an electron gun or ion gun.

20. The energy device of claim 11, wherein the vacuum chamber includes getter material to help preserve a vacuum in the vacuum chamber.

21. A method for delivering voltage to a device, the method comprising:
coupling an energy device to a circuit in the device, where the energy device comprising:
a container;
a lead wire positioned within the container, the lead wire including a first end and a second end; and
a vacuum chamber positioned within the container and coupled to the second end of the lead wire, the vacuum chamber including a plurality of charged particles circulating a magnet causing opposite charges to accumulate between the first end and the second end of the lead wire, resulting in a voltage difference in the lead wire; and
supplying the voltage difference to the device by coupling the first end of the lead wire to the circuit.
